(19) United States
(12) Patent Application Publication
(10) Pub. No.: US 2005/0060247 A1
(43) Pub. Date: Mar. 17, 2005

(54) Forwarder stocktaking management system and method

(76) Inventor: Yuan Hui Tien, Tu-chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/920,763

(22) Filed: Aug. 17, 2004

(30) Foreign Application Priority Data
Sep. 12, 2003 (TW) 92125268

(51) Int. Cl. G06F 17/60

(52) U.S. Cl. 705/28

(57) ABSTRACT

A system for forwarder stocktaking management (17) includes a plurality of user computers, a host, a plurality of client computers and a database. The host includes a basic information maintaining module, a stocktaking information generating module, an actual inventory inputting module, a stocktaking comparing module, a forwarder difference adjusting module, a settling module, and a statement generating module. The stocktaking information generating module is for generating stocktaking information needed in stocktaking process; the actual inventory inputting module is for inputting actual inventory data; the stocktaking comparing module is for comparing with stocktaking information and actual inventory data; the difference adjusting module is for adjusting differences between stocktaking information and actual inventory data; and the settling module is for accounts settling. The database stores the items set by users and the processing results generated in stocktaking process. A related forwarder stocktaking management method is also disclosed.

### BACKGROUND OF THE INVENTION

1. Field of the Invention

The present invention relates to a forwarder stocktaking management system and method, and particularly to a forwarder stocktaking management system and method that can take a stock in accordance with changes of inventory and settle accounts.

2. Background of the Invention

Proper inventory management is vital for the financial health of manufacturing corporations, and much attention has been paid to it. From the Re-ordering Point of the 20th century to the now very popular Enterprise Resource Planning (ERP), inventory management has undergone continuous research and evolved into a sophisticated field of endeavor. Stocktaking management is perhaps the most important task involved in inventory management.

Together with the development of supply chain management, many manufacturing corporations maintain more than one kind of warehouses. For example, goods are stored in a co-operator's Vendor Managed Inventory (VMI). In another example, ownership of inventory and risk for inventory are separated. That is, goods are left with a forwarder, who is not the owner of the goods but who still bears the risk of maintaining the goods safely. Management of inventory accounts is correspondingly complicated. How to manage inventory effectively over a period of time, and in particular how to ensure that book stocktaking information matches actual inventory, are both very important for effective inventory management. With the development of information technology and the widespread use of computers, it is possible for an inventory manager to accurately and timely manage warehouses. Japan Pat. No. 2001,108,912 published on Apr. 3, 2001 and entitled “Stocktaking Managing Method and Stocktaking System by Image Recognition” discloses methods and systems for automatic stocktaking using vidicons, cameras and counters. However, the system and method cannot adequately generate stocktaking information automatically. In addition, the system and method cannot compare book stocktaking information with data on actual inventory, or settle accounts based on such comparisons. What is needed is a system which effectively manages warehouses maintained by to a supplying corporation and its co-operator, which compares book stocktaking information with actual inventory data, and which processes related accounts.

### SUMMARY OF THE INVENTION

Accordingly, a main objective of the present invention is to provide a forwarder stocktaking management system and method which can automatically manage changes of inventory of a corporation and its co-operator, compare book stocktaking information with actual inventory data, and settle accounts.

To accomplish the above objective, the present invention discloses a forwarder stocktaking system particularly suited to consignment sales. A supplier delivers goods to consignment agents via forwarders. Ownership of the goods belongs to the supplier before the goods are sold to customers. The forwarders transport the goods, bear storage risks and get commissions. It is necessary to perform stocktaking frequently to assure the accounts agree with actual inventory. The forwarder stocktaking management system includes a plurality of user computers, a plurality of client computers, a host and a database. Each user computer provides an interactive user interface for users to maintain basic information, input inventory information and view statements. The users are computer operators of suppliers. Each client computer provides an interactive user interface for clients to transmit and receive information. The clients are computer operators of forwarders or consignment agents. The host can retrieve information through an external inventory system, the client computers and the user computers, then process the information and display results. The database is connected to the host for storing all kinds of information set and generated in the above-described processes. The information comprises document templates, forwarder warehouses, delivering goods information, commission standards and statement templates.

The host further comprises a basic information maintaining module which is for maintaining basic information needed in stocktaking, a stocktaking information generating module for generating stocktaking information, an actual inventory inputting module for inputting actual inventory data, a stocktaking comparing module for comparing the stocktaking information with the actual inventory data, a forwarder difference adjusting module for adjusting differences between the stocktaking information and the actual inventory data, a supplier settling module for settling accounts when the updated inventory information agree with the actual inventory data, and a statement generating module for generating statements according to terms set by users.

Further, the present invention provides a forwarder stocktaking management method comprising steps of: (a) maintaining basic information; (b) generating stocktaking information; (c) inputting actual inventory data; (d) comparing the stocktaking information with the actual inventory data, adjusting differences if the stocktaking information does not agree with the actual inventory data, settling accounts by the supplier if the stocktaking information agree with the actual inventory data; and (e) generating statements.

The forwarder stocktaking system and method of the present invention may be used for transmission of needed information via computers and networks, comparing the stocktaking information with the actual inventory data and adjusting differences between the stocktaking information and the inventory data, and then settling relative accounts. Those functions of the stocktaking system make inventory management effective and timely.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware infrastructure of a forwarder stocktaking management system in accordance with the preferred embodiment of the present invention;

FIG. 2 is a schematic diagram of main function units of a host of the forwarder stocktaking management system of FIG. 1; and

FIG. 3 is a flowchart of a preferred method for implementing the forwarder stocktaking management system of the present invention.

### DETAILED DESCRIPTION OF THE INVENTION

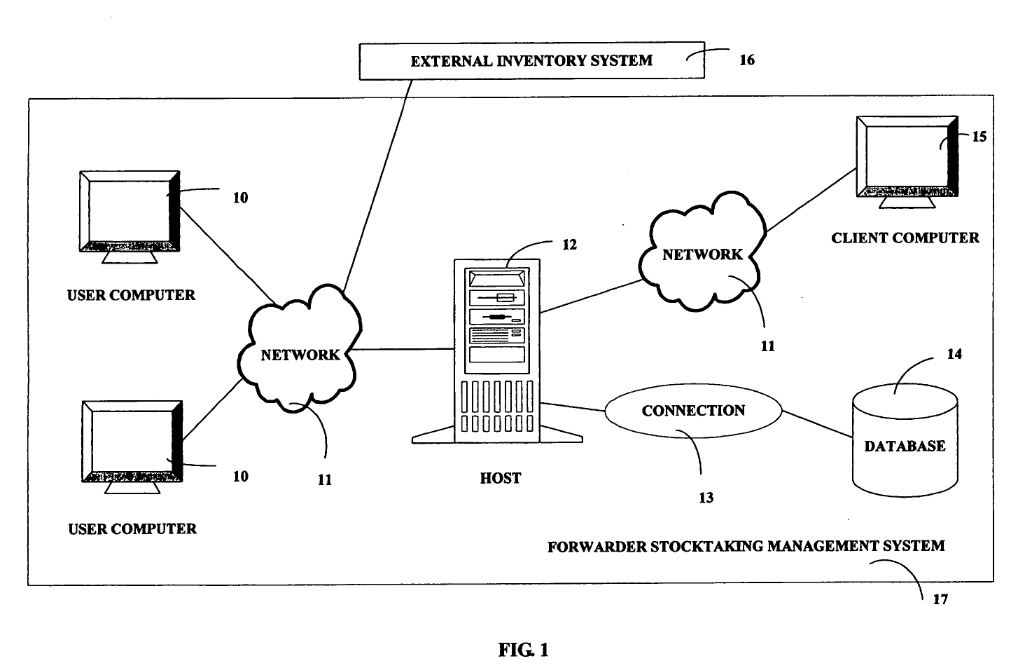

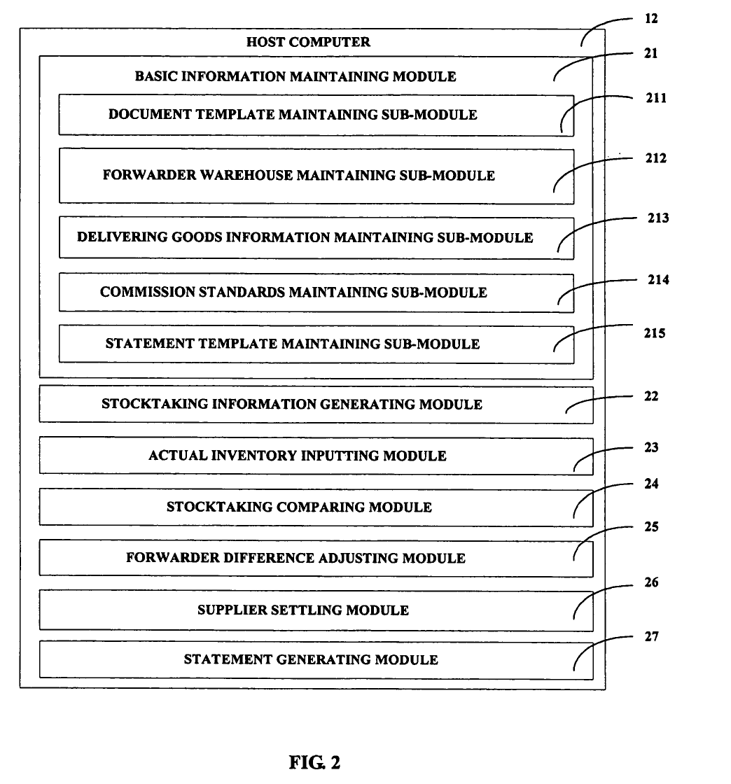

FIG. 1 is a schematic diagram of hardware infrastructure of a forwarder stocktaking management system (“the system”) 17 in accordance with the preferred embodiment of the present invention. The system 17 comprises a plurality of user computers 10, a host 12, a database 14, and a plurality of client computers 15 (only one shown). The user computers 10 are connected to the host 12 through an electronic communications network 11. The host 12 is connected to the database through a connection 13, and to the client computers 15 through the network 11. The system 17 is connected to an external inventory system 16 through the network 11. The external inventory system 16 provides inventory information used to generate stocktaking information. The network 11 may be a local area network, a wide area network, or another suitable type of electronic communications network. The connection 13 is a database connectivity such as an Open Database Connectivity (ODBC) or a Java Database Connectivity (JDBC). Each user computer 10 provides an interactive user interface for users to maintain basic information, input inventory information and view statements. The users are computer operators of suppliers. Each client computer 15 provides an interactive user interface for clients to transmit and receive information. The clients typically are computer operators of forwarders or consignment agents. The host 12 includes a plurality of function units (described in detail below in relation to FIG. 2). The host 12 can retrieve information from the external inventory system 16, the client computers 15 and the user computers 10, process the information, and display results of the processing. The database 14 stores all kinds of information set and generated in the above-described processes. The information comprises document templates, forwarder warehouses, delivering goods information, commission standards and statement templates which are explained in more detail blow.

FIG. 2 is a schematic diagram of main function units of the host 12. The host 12 comprises a basic information maintaining module 21, a stocktaking information generating module 22, an actual inventory inputting module 23, a stocktaking comparing module 24, a forwarder difference adjusting module 25, a supplier settling module 26, and a statement generating module 27.

The basic information maintaining module 21 maintains basic information, including by way of adding, modifying, searching and deleting basic information. The basic information maintaining module 21 comprises a document template maintaining sub-module 211, a forwarder warehouse maintaining sub-module 212, a delivering goods information maintaining sub-module 213, a commission standards maintaining sub-module 214, and a statement template maintaining sub-module 215. The document template-maintaining sub-module 211 is for maintaining all kinds of documents used in stocktaking. The documents comprise transfer bills, recycle bills, sales slips, returned sales reports, receivable vouchers, payable vouchers, and so on. A transfer bill is used for recording a name of goods and a quantity taken by a forwarder. The goods are transferred to the forwarder's warehouse according to the transfer bill. A recycle bill is sent by a consignment agent when it receives the goods delivered by a forwarder. The recycle bill records the delivering of goods, for the purpose of tracking quantities of goods delivered by the forwarder each day. Sales slips and returned sales reports are filled in by consignment agents to record actual sales. The forwarder warehouse maintaining sub-module 212 is for maintaining each forwarder's warehouse and cover scope. The warehouses are respectively classified according to names of forwarders. That is, different forwarders are assigned to different warehouses. Each forwarder covers a particular geographical area of destinations, hereinafter called an operation area. Consignment agents located in a particular operation area are assigned to the corresponding forwarder. The delivering goods information maintaining sub-module 213 is for maintaining information on delivering of goods. The information may include names of goods, numbers of goods, specifications, categories, quantities, and unit prices. The commission standards maintaining sub-module 214 is for maintaining methods of calculating commissions. For example, some methods are based of the kind of document generated during a transaction of goods. That is, total accounts of redemption bills or sale slips etc. are calculated, then a commission is calculated according to a fixed rate. Other methods include calculating a fixed commission according to a name of the goods, or calculating a fixed commission according to sale prices of the goods. The statement template maintaining sub-module 215 is for maintaining statement templates used in stocktaking. The statements comprise sales templates, forwarders' inventory lists, consignment agents' accounts receivable lists, forwarders' accounts receivable lists, and commissions payable to forwarders. The basic information is stored in the database 14.

The stocktaking information generating module 22 is used for generating information needed in stocktaking. When a forwarder takes delivery of goods, the stocktaking information generating module 22 derives inventory information from the external inventory system 16, and transfers the quantity of the goods delivered by the forwarder to the forwarder's warehouse. The stocktaking information generating module 22 also derives and verifies related data in documents obtained from the client computers 10, and updates the inventory quantity of the forwarder's warehouse. Said documents comprise redemption bills, sales slips, returned sales reports, and so on. Said related data comprise sales quantities, returned sales quantities, adjusted quantities, and quantities urgently applied for recycling. The stocktaking information generating module 22 can automatically generate a forwarder's inventory information for performing stocktaking. The inventory information comprises beginning inventory, transferred inventory, recycled inventory, sales quantities, returned quantities, and ending inventory. The inventory information is prepared as a working draft and stored in the database 14.

The actual inventory inputting module 23 is used for inputting actual inventory data. After printing out a working draft, the supplier and the forwarder determine an actual inventory. The actual inventory inputting module 23 maintains the actual inventory data. The actual inventory data are stored in the database 14.

The stocktaking comparing module 24 is used for comparing the information on a working draft with the corresponding actual inventory data. That is, the stocktaking comparing module 24 retrieves data on the working draft from the stocktaking information generating module 22, retrieves the actual inventory data from the actual inventory inputting module 23, and performs an item by item comparison.

The forwarder difference adjusting module 25 adjusts differences between actual inventory data and data on a working draft if they do not match each other. First, the forwarder difference adjusting module 25 discounts factors as such as human error in stocktaking and in accounting. Then the forwarder difference adjusting module 25 automatically calculates the differences, verifies the differences, and adds the differences to the forwarder's sales information. Furthermore, the forwarder difference adjusting module 25 changes the working draft to account for the differences, and calculates an account receivable of the forwarder based on the working draft. At the same time, the inventory information generating module 22 obtains updated inventory information of the forwarder's warehouse from the forwarder difference adjusting module 25, and maintains the inventory information automatically. The updated inventory information is stored in the database 14.

The supplier settling module 26 is used for settling accounts when the updated inventory information agrees with the actual inventory. That is, the supplier settling module 26 summarizes accounts receivable of consignment agents and forwarders, and calculates commissions payable to forwarders. For example, when a commission standard is set according to a fixed commission rate and the sum of all redemption bills, the supplier settling module 26 calculates total accounts of all redemption bills of the forwarder in the settling term, multiplies the total accounts by the fixed commission rate, and thus arrives at the commission payable to the forwarder. The accounts receivable and the accounts payable are stored in the database 14.

The statement generating module 27 obtains requested information from the database 14, retrieves suitable statement templates from the statement template maintaining sub-module 215, and generates statements accordingly.

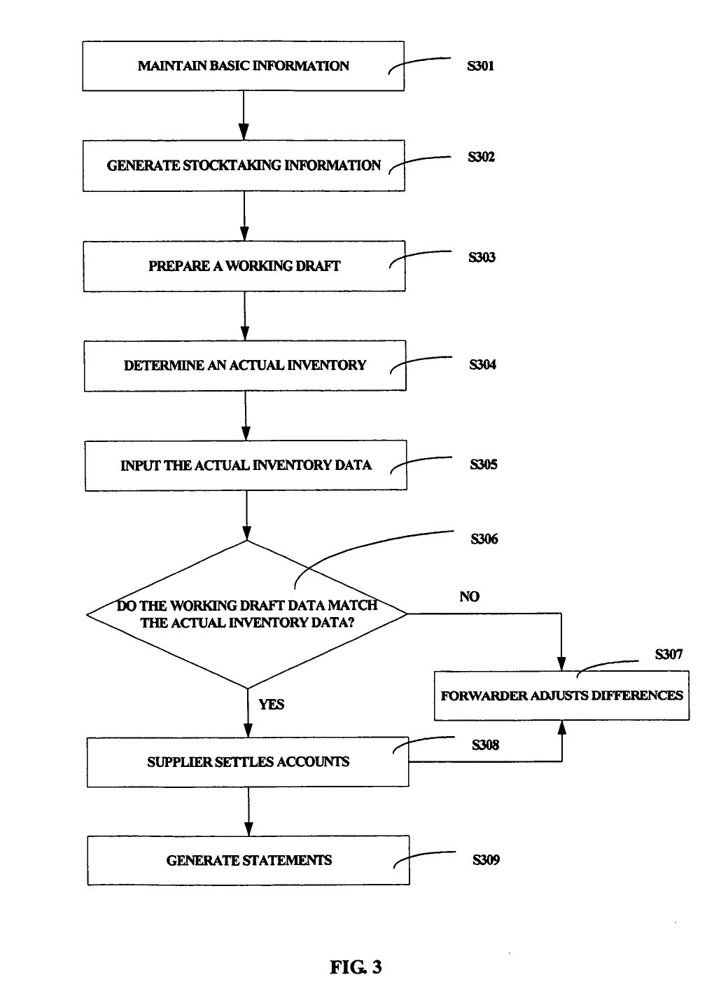

FIG. 3 is a flowchart of a preferred method for implementing the system 17 of the present invention. In step S301, the basic information maintaining module 21 maintains basic information. In step S302, the inventory information generating module 22 generates stocktaking information. In step S303, a working draft is prepared according to the inventory information. In step S304, the supplier and the forwarder determine an actual inventory in the forwarder's warehouse. In step S305, the actual inventory inputting module 23 inputs actual inventory data. In step S306, the stocktaking comparing module 24 compares the actual inventory data with the data on the working draft. If the actual inventory data do not match the data on the working draft, the procedure goes to step S307. In step S307, the forwarder difference adjusting module 25 adjusts the differences between the actual inventory data and the data on the working draft. That is, the forwarder difference adjusting module 25 discounts factors such as human error in stocktaking and in accounting, automatically calculates the differences, verifies the differences, and adds the differences to the forwarder's sales information. Furthermore, the forwarder difference adjusting module 25 changes the working draft to account for the differences, and calculates an account receivable of the forwarder based on the working draft. At the same time, the inventory information generating module 22 obtains updated inventory information of the forwarder's warehouse from the forwarder difference adjusting module 25, and maintains the inventory information automatically. If the actual inventory data match the data on the working draft, the procedure goes directly to step S308. In step S308, the supplier settling module 26 settles accounts when the updated inventory information agrees with the actual inventory. That is, the supplier settling module 26 summarizes accounts receivable of consignment agents and forwarders, and calculates commissions payable to forwarders. Finally, in step S309, the statement generating module 27 generates statements. The statements can be displayed to a user through an interface of a relevant user computer 10, stored in the database 14, and printed.

Although the present invention has been specifically described on the basis of a preferred embodiment and a preferred method, the invention is not to be construed as being limited thereto. Various changes and modifications may be made to the embodiment and method without departing from the scope and spirit of the invention.

1. A forwarder stocktaking management system for taking a stocktaking and settling accounts according to changes of inventory, comprising:
a plurality of user computers, each user computer providing a user interface for users to maintain information;
a plurality of client computers, each client computer providing a user interface for clients to transmit and receive information;
a database for storing information; and
a host comprising:
a basic information maintaining module for maintaining basic information needed in stocktaking;
a stocktaking information generating module for generating stocktaking information needed in stocktaking;
an actual inventory inputting module for inputting actual inventory data;
a stocktaking comparing module for comparing the stocktaking information with the actual inventory data; and
a forwarder difference adjusting module for adjusting differences between the stocktaking information and the actual inventory data; and
a supplier settling module for suppliers to settle accounts.

2. The forwarder stocktaking management system according to claim 1, wherein the host further comprises a statement generating module for generating statements according to terms set by users.

3. The forwarder stocktaking management system according to claim 1, wherein the basic information maintaining module comprises:
a document maintaining sub-module for maintaining documents used in stocktaking;
a forwarder warehouse maintaining sub-module for maintaining forwarder warehouses and operation areas;
a delivering goods maintaining sub-module for maintaining delivering goods information;
a commission standards maintaining sub-module for maintaining methods of calculating commissions; and
a statement template maintaining sub-module for maintaining statements.

4. The forwarder stocktaking management system according to claim 1, wherein said adjusting differences comprises automatically calculating differences between the stocktaking information and the actual inventory data, verifying and adding the differences to sales information, removing the differences from the forwarder's warehouse, generating the forwarder's accounts receivable, and updating the stocktaking information.

5. The forwarder stocktaking management system according to claim 1, wherein said supplier's settling of accounts comprises steps of summarizing accounts receivable of consignment agents and forwarders, and calculating commissions payable of forwarders.

6. A forwarder stocktaking management method, comprising the steps of:
maintaining basic information;
generating stocktaking information;
inputting actual inventory data;
comparing the stocktaking information with the actual inventory data, and adjusting differences when the stocktaking information does not match the actual inventory data;
settling accounts by a supplier if the stocktaking information matches the actual inventory data; and
generating statements.

7. The method according to claim 6, wherein adjusting differences comprises the steps of automatically calculating differences between the stocktaking information and the actual inventory data, verifying and adding differences to sales information, removing the differences from the forwarder's warehouse, generating the forwarder's accounts receivable, and updating the stocktaking information.

8. The method according to claim 6, wherein the supplier settling accounts comprises the steps of summarizing the accounts receivable of consignment agents and forwarders, and calculating commissions payable of forwarders.

9. The method according to claim 6, further comprising the step of a supplier settling accounts by adjusting the differences.

10. A forwarder stocktaking management method, comprising the steps of:
maintaining basic information;
obtaining stocktaking information;
inputting actual inventory data;
comparing the stocktaking information with the actual inventory data, and adjusting differences if the stocktaking information does not match the actual inventory data; and
generating statements.
